(19) United States
(12) Patent Application Publication
(10) Pub. No.: US 2020/0262168 A1
(43) Pub. Date: Aug. 20, 2020

(54) A Standalone Waste Compaction Device

(71) Applicant: Leonardo S.r.I., Figino Serenza (CO) (IT)

(72) Inventor: Thomas Griffith, Bella (IE)

(21) Appl. No.: 16/648,224

(22) PCT Filed: Sep. 17, 2018
(86) PCT No.: PCT/IB2018/057114

§ 371 Date: Mar. 17, 2020

(30) Foreign Application Priority Data
Sep. 18, 2017 (GB) 1715022.8

(51) Int. Cl. B30B 1/04; B30B 1/00; B30B 15/28; B65F 1/14; B65F 1/16

(52) U.S. Cl. CPC B30B 1/04; B30B 1/006; B30B 15/281; B65F 1/1426; B65F 2210/148; B65F 1/1405; B65F 1/1615; B65F 2210/168; B65F 2210/144; B65F 1/163

(57) ABSTRACT

A standalone waste compacting device includes an enclosure having a removable bin; a cover section on the enclosure incorporating at least one solar power unit, at least one storage battery and control unit, at least one inwardly pivoting user access flap having a dual locking control mechanism, at least one recessed foot pedal mechanism for opening the access flap, a detachable independent compaction unit comprising a scissor linkage and lever linkage system, and at least one service access means.

### RELATED APPLICATIONS

This application claims priority to international Patent Cooperation Treaty application no. PCT/IB2018/057114, filed on 17 Sep. 2018, and which claims priority to GB patent application no 1715022.8, which was filed on 18 Sep. 2017. Each of the foregoing applications is incorporated here by reference in its entirety.

### BACKGROUND

The present invention relates to a standalone waste compaction device powered primarily by solar energy.

Street bins can quickly fill up to overflowing which is very unsightly in addition to being a health hazard. Solar street bins are known. European Patent Application no. EP 1638704 (Big Belly Solar) describes a bin fitted with a solar-powered waste compactor which crushes rubbish to increase the capacity of the bin by six to eight times that of a traditional litter bin. Sensors in the bin detect when it's full and send a message to council staff letting them know the bin needs to be emptied. Specialized equipment is required to collect the rubbish from the bin.

There is a need for an improved standalone waste compaction device.

### SUMMARY

According to the invention there is provided a standalone waste compacting device comprising:

an enclosure comprising a removable bin;

a cover section on the enclosure incorporating at least one solar power unit;

at least one storage battery and control unit;

at least one inwardly pivoting user access flap comprising a dual locking control mechanism;

at least one recessed foot pedal mechanism for opening the access flap;

a detachable independent compaction unit comprising a scissor linkage and lever linkage system; and

at least one service access means.

In one embodiment of the invention the solar power unit comprises a polycarbonate cover with a photovoltaic unit mounted beneath it the photovoltaic unit connected to the storage battery.

In one embodiment of the invention the device comprises at least one alternative source of energy to supplement the energy stored in the batteries. Preferably the energy is mechanical energy generated by operation of the foot pedal mechanism. Preferably the energy is mechanical energy generated by operation of a compaction assist spring during a compaction cycle.

In one embodiment of the invention the dual locking system on the access flap comprises an electronic lock system and a mechanical lock system. Preferably the electronic lock system is activated prior to compaction and the mechanical lock system activates once compaction commences.

In one embodiment of the invention the pivoting access flap comprises a substantially L-shaped planar unit which pivots inwardly on a flap pivot. Preferably the mechanical lock comprises a lock pivot and lock head which presses down when activated on the short upper end of the L-shaped flap.

In one embodiment of the invention the inwardly pivoting user access flap is operated by hand or by operation of the foot pedal. Preferably the opening of the access flap by hand and by operation of the foot pedal are independent of one another.

In one embodiment of the invention the pivoting access flap is controlled by a damper assembly. Preferably the damper assembly comprises a gas strut directly connected to the foot pedal and connected by a link arm to the lock head on the access flap.

In one embodiment of the invention the foot pedal is connected to a generator.

In another embodiment of the invention the compaction unit comprises extendable sideguards which extend when the scissor linkage extends to fully enclose the compaction unit.

In another embodiment of the invention the control unit comprises a general controller, a solar controller, an ultrasonic sensor unit, and an “intelligent fuel gauge”. Preferably the ultrasonic sensor unit determines when maximum capacity has been reached in the removable bin.

In one embodiment of the invention the compaction pressure is regulated by the controller.

In one embodiment of the invention the device comprises at least one sensor. Preferably the device comprises a sensor actuator located directly on the access flap to alert the controller when the flap is damaged or vandalised.

In one embodiment of the invention the controller comprises a bin locking system when the removable bin has reached maximum capacity. Preferably the bin locking system locks the access flap closed.

In one embodiment of the invention the controller comprises a sensor to detect bombs and/or dangerous chemicals and signal the controller to lock down the compacting device.

In one embodiment of the invention the controller communicates information remotely from the sensors on the capacity status, diagnostics or any other issues to a control center.

In another embodiment of the invention the controller receives information remotely from a control centre to lock down and prevent access to the bin.

In one embodiment of the invention the device comprises a recessed cigarette bin.

In another embodiment of the invention the device comprises an integrated fire extinguisher system.

### BRIEF DESCRIPTION OF THE FIGURES

The invention will be more clearly understood from the following description thereof with reference to the accompanying drawings in which:

FIG. 1 is a perspective view of the bin according to the invention;

FIG. 2 is a perspective view from the rear of the bin of FIG. 1;

FIGS. 3 (a) to (f) are perspective views of the bin according to different embodiments of the invention;

FIGS. 4 (a) and (b) are perspective views of the bin according to another embodiment of the invention;

FIG. 5 is a partial cross sectional view of the inside of the bin according to the invention;

FIG. 6 is a side view of the compaction unit of the bin according to the invention;

FIG. 7 is an exploded view of the dual locking mechanism operating the access flap on the bin according to the invention;

FIG. 8 is a side view of a foot pedal mechanism to operate the access flap of the bin according to the invention;

FIG. 9 is a side view of a foot pedal mechanism according to another embodiment of the invention;

FIG. 10 is an exploded view of the foot pedal mechanism of FIG. 9; and

FIG. 11 is a further view of the foot pedal mechanism of FIG. 9.

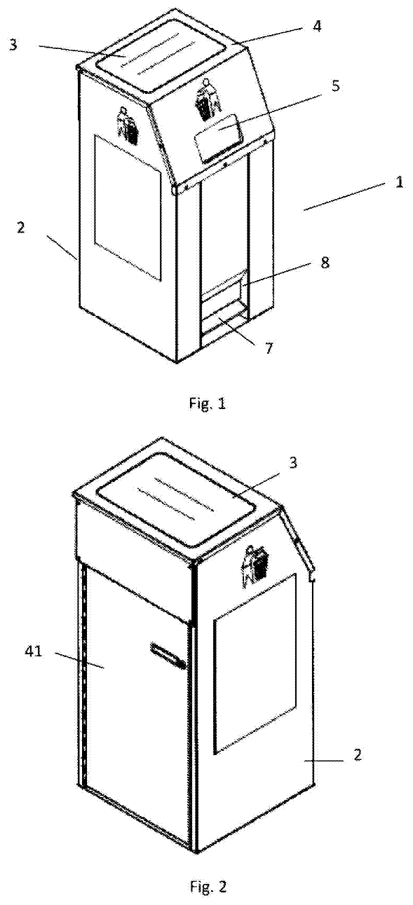

### DESCRIPTION

One problem with known waste bin compactors is that they require specialised equipment to collect the rubbish. Manual handling & lifting of rubbish bins is labor intensive and has lots of associated risks in the type of rubbish that can be handled.

Another problem with solar powered waste bin compactors is that the bins do not always receive sufficient solar energy to maintain the compacting action. This frequently results in overfilled and overflowing bins.

The standalone waste compactor of the present invention uses standard commercial wheeled waste bins as the removable bin and compactor receptacle. Standard commercial waste bins allow existing bin lorries fitted with bin lifting equipment to pick up and dispose of the waste without further cost or training to the waste company.

Using standard commercial waste bins also removes any issues of manual handling and other lifting hazards. There is no need for a bin collecting operator to lift the bins thereby eliminating any related health risks. The bin collecting operator is also isolated from the danger of syringes and other sharp objects protruding through plastic bag containers and posing a health risk to the operator. The operator is isolated from unhygienic risks such as potential contact with Bio Hazards Objects—e.g. feces, vomit and used condoms from split bags or containers when lifting into a removal truck. In addition as commercial bins are typically larger, more material can be compacted before the bin needs to be collected.

To protect users and the general public from the working parts of the bin and also to protect the unit against vandalism, the collecting bin, compactor and all working parts are enclosed within an enclosure or chamber. This chamber may be designed to be blast proof against terrorist threats.

The standalone waste compactor device of the present invention does not have access to a utility supplied power source and is primarily solar powered. The solar energy is stored in internal batteries. The size of both the internal batteries and the solar panels are limited by the available space and cost. When access to available solar power is constrained by the duration of day light periods, weather conditions or for other reasons the device has alternative sources of energy such as energy generated by mechanical means to supplement charging up the storage batteries.

The solar bin 1 of the present invention comprises an enclosure 2 with a polycarbonate top 3 allowing sun to penetrate through to a photovoltaic (PV) solar panel 4 mounted beneath it. The photovoltaic panel is positioned for exposure to the sun and power produced by the photovoltaic panel is stored in a storage battery in the unit. The solar bin 1 has at least one solar panel depending on the available suitable space.

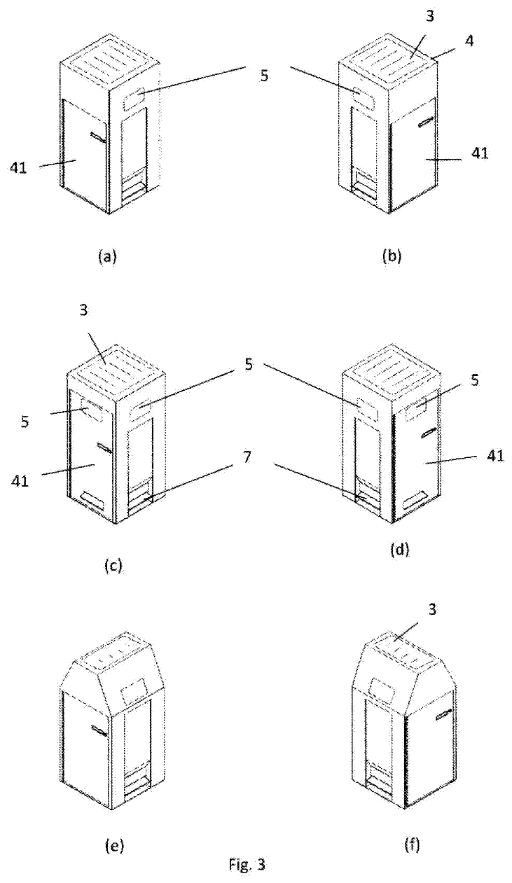

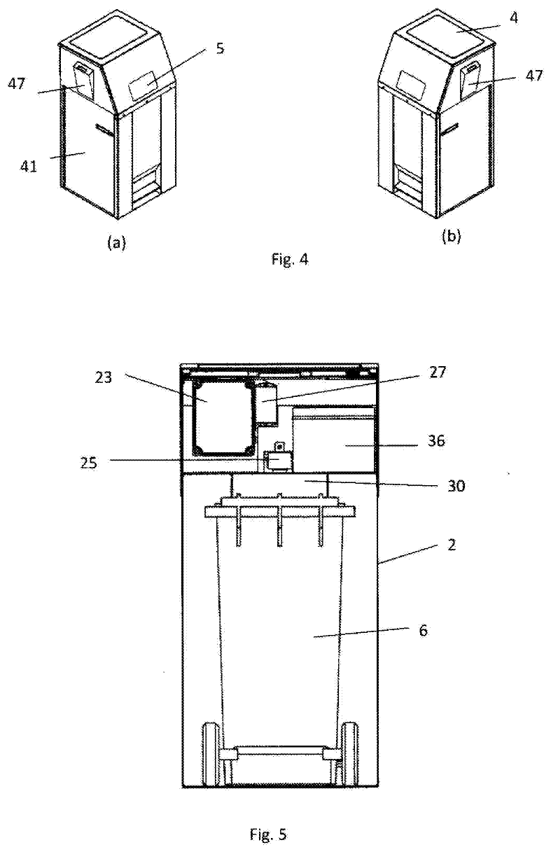

The front of the unit comprises one inwardly pivoting access flap 5 which allows users to put rubbish into the wheeled bin container 6 within the enclosure 2. As shown in FIGS. 3 (a) to (f) the unit may have more than one access flap 5 so that user access to the bin is not compromised no matter where the bin is located or positioned. The unit may have a user access flap 5 on every side.

A foot pedal 7 is located in a recess 8 on the lower end of the enclosure 2. The foot pedal 7 allows a user to open the access flap 5 and insert rubbish without their hands coming into contact with the bin. The recess 8 is designed to ensure that the user only approaches the pedal from the front protecting the user's feet from striking the pedal from the side or on the edge of the pedal. The recessed foot pedal 7 also avoids any risk to passer's of tripping or knocking into the pedal as is the case with protruding pedals. As shown in FIGS. 3 (c) and (d) the unit may have more than one foot pedal 7 located on different sides of the unit so that a user can open the access flap 5 on the bin no matter where the bin is located or positioned.

The inwardly pivoting access flap 5 allows users to put items into the wheeled bin container 6. The flap is a substantially planar L-shaped unit with the long arm 5a of the L-shape covering the access area and the short arm 5b extending into the enclosure 2. The planar L-shaped flap 5 pivots on a flap pivot 40.

The access flap 5 may be push operated by hand or by foot pedal operation at the discretion of the user. The foot pedal 7 gives a choice of operation as some users do not like touching bins. The foot pedal 7 operation allows the access flap 5 to be pushed open independently of the pedal 7. This prevents a crushing effect if a small foot is placed under the pedal 7 while pushing the access flap 5 open by hand.

The access flap 5 may be pushed open freely by hand. However the closing of the access flap 5 is carried out at a controlled pace using a using damper assembly. The damper assembly prevents any injury occurring if a hand is placed into the chute area 10 when the access flap 5 is no longer supported open. The damper assembly comprises a gas strut 11 directly connected to a sub-plate 1 on the foot pedal 7 and in turn connected to the access flap 5 by a link arm 13. The gas strut 11 is positioned to actuate on the foot pedal 7 and the access flap 5 returning both to a ready operational state in a single action. The pedal sub-plate 12 allows the pedal 7 to sit freely while mounted on the same pivot axis. Other suitable damper means such as a spring may be used to reduce the closing speed of the flap to prevent injury.

The use of an inwardly pivoting flap access 5 to the bin container 6 prevents odours from escaping from the bin and in addition prevents vermin from accessing the waste. The access flap 5 incorporates a safety feature to ensure that the access flap 5 is locked in a closed position during the compaction cycle to prevent persons from accessing the bin during the compaction process.

The access flap 5 locking system incorporates a two-part locking device, an electronic powered lock and a mechanical lock. Prior to compacting the controller actuates the electronic lock preventing users from operating the flap and once compaction commences the mechanical locking occurs.

The compactor head 22 moves on a vertical emphasis 23 from the head of the mechanical lock 21 which is held in tension by a spring 24, and moves into position ensuring that the flap 5 remains closed. The mechanical lock 21 comprises a lock pivot 25 and lock head 25a which presses down when activated on the short end 5b of the L-shaped flap 5b.

The contact angle from the lock 21 to the striking face 27 of the flap 5 is optimised to be as perpendicular as practicable so as to contain the flap when the flap 5 is struck at force.

During a compaction cycle the access flap 5 is locked with an electrically controlled actuator 20. As the compaction cycle commences, the mechanical lock moves into position as a second safety device and also as an energy saving device to reduce the power draw used by the primary lock, the electrically controlled actuator 20.

A sensor actuator 26 is located directly on the long end 5a of the flap 5 to alert the controller should the flap be damaged or vandalised that the compaction process cannot occur.

The compactor unit 30 is removable as a separate entity from the enclosure 2 for servicing. The compactor unit 30 incorporates a scissor linkage 31 and a lever linkage system 32.

The compactor unit 30 is removable as a separate entity from the enclosure 2 for servicing. The compactor unit 30 comprises a linear actuator 18, actuator mounting 19, and lever arm 17, connected to a scissor linkage 34 which in turn is connected to the compactor plate or head 22. Shrouding the linkage assembly 34 are the scissor linkage extendable sideguards 35 which prevents debris from entering into the scissor linkage assembly 34 and also acts as a second guard preventing persons from putting their hands into the scissor linkage 34, as it compacts and retracts, should there be a failure of the main safety devices or locks.

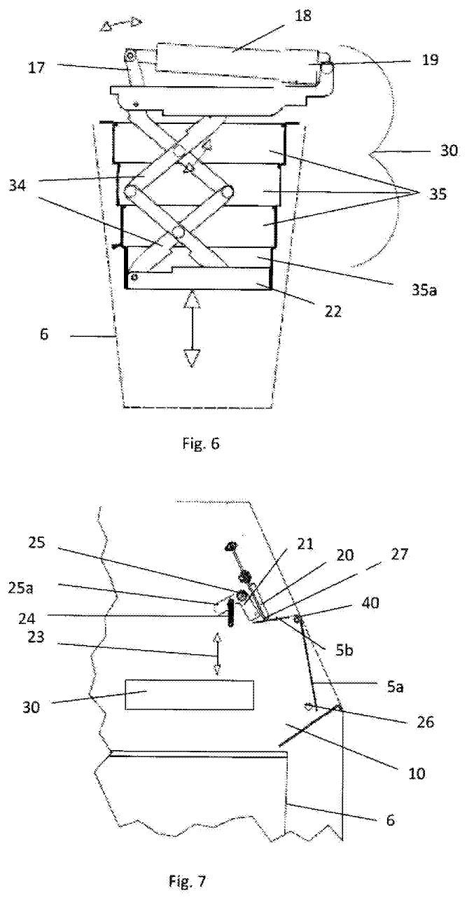

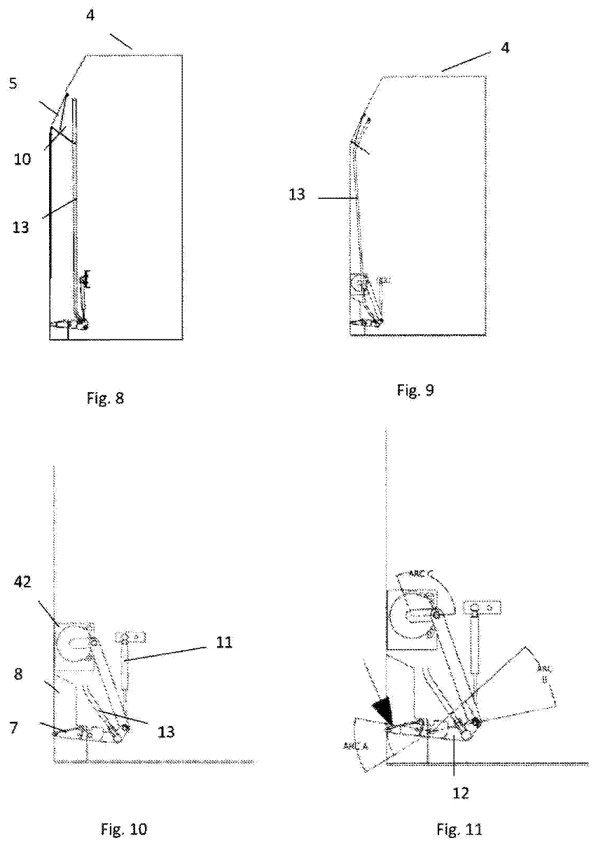

In operation the actuator 18 pushes the lever arm 17 though an arc giving optimum force through the lever as the angle of the actuation works through the perpendicular as shown in FIG. 6. The lever arm 17 forces the scissor linkage 34 to expand to its maximum allowable extension lowering the compactor plate 22 into the bin 6. Each set of extendable guards 35 drops as the compactor plate 22 lowers. To retract the compactor plate 22, the linear actuator 18 pulls in reverse working the scissor linkage 34 and lifting the compactor unit 30 back into its folded resting position. The lower guard 35a catches each set of extendable guards on the return stroke, pulling them up into retracted position.

The compacting unit 30 in its folded resting position utilises minimal space in the bin overall.

The linkage system of the present invention also reduces the amount of torque required to close the compactor unit in the final stages, thereby reducing the power requirement on the unit.

The compaction pressure is regulated by controlling the electrical current to the actuator. This is monitored by the controller and it will retract the compactor upon reaching the current limit on an outward stroke. This control limits the amount of compaction in the bin and acts as a safety device as not to damage the bin container.

A bomb detection and/or chemical sensor may be located on the compactor head. Such sensors would become energised during the compaction process to sense for bombs or improvised explosive devices. The sensor would create a signal to be sent via the controller to raise an alarm. Alternatively the sensors may be located at the chute entrance to the bin and would be activated upon flap opening with an energy saving controller to have the unit switched on for a period of time to allow material to be checked when placed into the bin after the flap has been opened. A signal may be sent remotely to the controller to cause the compactor head to be lowered locking the access flap closed in the event of a bomb threat. Citywide all bins may be locked down in this way preventing access to the enclosure of the bin.

The odour of the compacted material may be reduced by a spray that occurs after each compaction cycle. A mechanical actuation of the spray occurs on the return of the compactor. In addition to preventing odours, an anti-vermin spray or insect spray may also be added to the cycle.

Service access is through a large door 41 located on the rear of the enclosure 1. Alternatively service access may be located on either side of the enclosure 2. This ensures easy access to the removable bin no matter what the position of the standalone unit. A sensor actuator is located on the door, preventing a compaction cycle from commencing if the door 6 is open. The door is key locked closed preventing general public from accessing the bin.

As shown in FIG. 5 the service shelf 33 within the device 1 comprises a controller 23, solar controller 27, ultrasonic sensor unit 25 and a battery 26.

Fitted separately but preferably recessed into the main enclosure is a cigarette bin 47. Being separate from the main body of the unit reduces the chance of fire entering the main bin and being recessed into the outer enclosure of the device 1 reduces the opportunity for vandalism.

Further fire precautions may include a fitted automatic fire extinguisher system incorporated by any suitable means into the design of the machine.

The controller comprises a system of “rubbish level measuring” preventing the removable bin from being over filled and preventing the general public from accessing the bin. The ultrasonic sensor unit 25 measures the height of waste in the bin. The sensor signals the controller which then prevents the access flap from being opened when a certain height of compacted rubbish has been reached. This system may be disabled if required.

There are a range of bin measuring devices and administration software commercially available for routing traffic to optimise fuel economy to the appropriate full bin. The ultrasonic sensor may be connected via software and communicate through GSM, Sigfox and LoRa or other TOT methods to a central data system to notify the waste company responsible for the bin when the bin needs to be emptied.

A bin “Lock Out” system is also incorporated. This prevents overfilling of the bin and the chute area, reducing servicing time and reducing health and safety hazards for the waste operator in not having to pull waste material from the chute. The lock out system is connected to the controller which connects to a data centre to notify that the bin requires urgent emptying. The controller may also be accessed remotely whereb at the touch of a button all bins in a given area may be locked down. The compactor head is lowered which engages the mechanical lock and the access flap is locked.

The standalone waste compacting device of the present invention may be accessed remotely for diagnostics, battery monitoring or any malfunction issues.

The standalone waste compacting device of the present invention incorporates an efficient management of energy to improve the effectiveness of the unit.

The compaction unit of the present invention has incorporated a number of ways to minimise all non-essential energy usage. The continuous energy drain on the system is measured and documented and may be used to create a base energy budget or quiescent energy requirement for each bin.

The call for compaction is intelligent and responsive to demand and based on the base quiescent energy, i.e., compaction of the waste material in the bin only occurs when it is necessary to compact.

To minimise energy usage the distance (level) measurement action only occurs if materials are added to the bin. A distance measuring device, such as an ultrasonic device or the like, may be used to establish the level of waste materials in the bin. If the level of waste materials is above a defined limit a compaction cycle is initiated.

Alternatively or additionally the number of operations of the “access flap” may be used as indicative of materials added and the distance measuring sensor may activate when the flap is operated a defined number of times.

The actuator on the compactor may be fitted with an extension distance transducer. This is used to estimate the compacted materials level.

The compaction unit of the present invention optimises the compaction efficiency by pausing the actuator at maximum extension to ensure that materials are fully compacted. In this way any trapped air is allowed escape maximising compaction. A spring or similar mechanism is used to ensure the compacting force is applied when the compacting actuator is paused.

The compaction unit of the present invention may comprise an intelligent battery “fuel gauge”. Only in response to certain criteria does compaction occur. For example compaction will operate only on material level in the lower quarter of the bin, compaction does not occur in the lower 1% of the bin and any changes in charge level is reported remotely or locally by the system.

In the event of the battery level falling below a predefined level, a message is issued to the remote system manager entity. Several actions may be taken in response such as emptying and/or replacing the bin, charging the system battery or replacing the battery with a fully charged unit. An external power source may also be fitted to the machine to charge the battery if required.

In addition to solar power the unit comprises alternative means of energy to supplement charging up the storage batteries. The foot pedal mechanism may be used to generate energy. As shown in FIGS. 9 to 11 the pedal actuation and flap actuation are connected through the pedal sub plate 12. Depression of the pedal 7 will transmit energy through the connecting rod 13 to the generator 42. The gas strut or damper 11 ensures the return stroke of the pedal actuation. Where there is more than one foot pedal each pedal may have an individual generator or the pedals may share a generator or generators.

A compacting assist spring may also be attached to the scissor linkage to help with the compacting and produce energy while doing so to supplement the stored energy in the storage battery.

The completely enclosed unit of the waste compactor bin of the present invention means that odours are reduced thereby limiting access to vermin and other animals.

The enclosure surround is large enough to facilitate advertising and where possible screens may be fitted to offer information.

The invention is not limited to the embodiment hereinbefore described, with reference to the accompanying drawings, which may be varied in construction and detail.

1. A standalone waste compacting apparatus comprising:
an enclosure comprising a removable bin;
a cover section on the enclosure incorporating at least one solar power unit;
at least one storage battery and a control unit;
at least one inwardly pivoting user access flap comprising a dual locking control mechanism;
at least one recessed foot pedal mechanism for opening the inwardly pivoting user access flap;
a detachable independent compaction unit comprising a scissor linkage and a lever linkage system; and
at least one service access means.

2. The apparatus of claim 1 wherein the solar power unit comprises a polycarbonate cover with a photovoltaic unit mounted beneath it the polycarbonate cover, the photovoltaic unit connected to the at least one storage battery.

3. The apparatus of claim 1 comprising at least one alternative source of energy configured to supplement an energy stored in the at least one storage battery, the alternative source of energy chosen from the list consisting of the recessed foot pedal mechanism and a compaction assist spring during a compaction cycle.

4. (canceled)

5. (canceled)

6. The apparatus of claim 1 wherein the dual locking control mechanism of the inwardly pivoting user access flap comprises an electronic lock system and a mechanical lock system.

7. The apparatus of claim 6 wherein the electronic lock system is configured for activation prior to compaction and the mechanical lock system is configured for activation once compaction commences.

8. The apparatus of claim 6 wherein the inwardly pivoting user access flap comprises a substantially L-shaped planar unit which pivots inwardly on a flap pivot.

9. The apparatus of claim 8 wherein the mechanical lock system comprises a lock pivot and a lock head configured to press down when activated on the short upper end of the L-shaped flap.

10. The apparatus of claim 1 wherein the inwardly pivoting user access flap is configured for operation by hand or by operation of the recessed foot pedal.

11. The apparatus of claim 10 wherein the inwardly pivoting user access flap opening by hand and by operation of the recessed foot pedal are independent of one another.

12. The apparatus of claim 10 wherein closing of the inwardly pivoting user access flap is controlled by a damper assembly.

13. The apparatus of claim 12 wherein the damper assembly comprises a gas strut directly connected to the recessed foot pedal and connected by a link arm to a lock head on the inwardly pivoting user access flap.

14. (canceled)

15. The apparatus of claim 1 wherein the control unit comprises a control unit chosen from the list consisting of a general controller, a solar controller, an ultrasonic sensor unit, and an “intelligent fuel gauge”.

16. The apparatus of claim 1 wherein a compaction pressure is regulated by the control unit.

17. The apparatus of claim 1 wherein the detachable independent compaction unit comprises extendable sideguards which extend when the scissor linkage extends to fully enclose the detachable independent compaction unit.

18. The apparatus of claim 1 comprising at least one sensor.

19. The apparatus of claim 18 comprising a sensor actuator located directly on the inwardly pivoting user access flap, the sensor actuator configured to alert the control unit when the inwardly pivoting user access flap is damaged or vandalised.

20. The apparatus of claim 1 wherein the control unit comprises a bin locking system configured to lock the removable bin when the removable bin has reached a maximum capacity.

21. The apparatus of claim 20 wherein the bin locking system locks the inwardly pivoting user access flap closed.

22. The apparatus of claim 1 comprising a sensor to determine when a maximum capacity has been reached in the removable bin.

23. (canceled)

24. The apparatus of claims 18 wherein the control unit is configured to communicate information remotely from the at least one sensor, the information chosen from the list consisting of capacity status and diagnostics.

25. (canceled)

26. (canceled)

27. (canceled)
